(19) United States
(12) Patent Application Publication
(10) Pub. No.: US 2020/0288923 A1
(43) Pub. Date: Sep. 17, 2020

(54) TOILET FOR SANITATION SYSTEM

(71) Applicants: Robert C. Tsigonis, Fairbanks, AK (US); Alaska Native Tribal Health Consortium, Anchorage, AK (US)

(72) Inventors: John A. Warren, Anchorage, AK (US); Robert C. Tsigonis, Fairbanks, AK (US)

(21) Appl. No.: 16/888,422

(22) Filed: May 29, 2020

Related U.S. Application Data
(63) Continuation-in-part of application No. 16/508,148, filed on Jul. 10, 2019.
(60) Provisional application No. 62/853,940, filed on May 29, 2019.
(60) Provisional application No. 62/696,763, filed on Jul. 11, 2018.

(51) Int. Cl. A47K 11/02; C02F 1/00; E03D 9/04; E03F 5/18

(52) U.S. Cl. CPC A47K 11/02; C02F 1/001; C02F 2103/005; E03F 5/18; C02F 2303/02; E03D 9/04

(57) ABSTRACT

The disclosure relates to a waste collection system designed for handling liquid and solid waste without reliance on running water. The system is also designed with modular components adapted for in-home installation, where the system can be quickly assembled and disassembled as needed, such as for moving the components to a new location based on environmental conditions. Moreover, the system is designed to facilitate easy conversions between a waste-separating toilet design and a more streamlined non-waste-separating toilet design when desired to maximize flexibility of the overall system.

### RELATED APPLICATION DATA

This application is a nonprovisional of and claims the benefit under 35 U.S.C. § 119(e) of U.S. Provisional Patent Application No. 62/853,940, filed May 29, 2019, and is a continuation-in-part of and claims the benefit under 35 U.S.C. § 120 of U.S. patent application Ser. No. 16/508,148, filed Jul. 10, 2019, which is a nonprovisional of and claims the benefit under § 119(e) of U.S. Provisional Patent Application No. 62/696,763, filed Jul. 11, 2018, the disclosures of which are incorporated by reference herein in their entireties.

### TECHNICAL FIELD

The field of the present disclosure relates to improved body waste collection and sanitation systems, and in particular, to such systems designed for efficiently handling liquid and solid wastes while conserving water and minimizing odors. The described system is also designed to be portable and self-contained for easy in-home installation, and further designed for use in homes where conventional sewer and wastewater systems are not available.

### BACKGROUND

Many homes, especially those in developed nations, include at least one bathroom with a toilet for receiving and handling human waste and a sink with potable water for washing hands and maintaining appropriate hygiene. Such bathrooms tend to operate with plumbing and sewage systems that provide running water to facilitate flushing and removal of the human waste and to allow users to wash their hands with clean water. While plumbing systems are widely employed in many homes, such plumbing systems may not be available for all homes for various reasons. For example, in extremely cold climates, plumbing and sewage systems may be difficult to employ because of freezing issues. In coastal regions, erosion issues may impact such systems and require more portable solutions to accommodate people periodically moving further inland due to the eroding coastline. In impoverished regions, homes may not be permanent structures and water may be scarce or unavailable, thereby making it impractical to install such complex plumbing systems.

Portable lavatory systems are generally known and used in many different settings in our modern society. For example, such systems are commonly used during outdoor social events, such as, sporting events and concerts, or during construction projects for the convenience of the construction workers. These portable lavatories are typically self-contained systems in a singular stall or structure with a holding tank located under the toilet or urinal for receiving and storing the waste. Typically, such systems do not have any flushing water and lack proper venting to handle odor from the waste accumulating in the holding tank. While such systems are useful for temporary events, they are generally unsanitary and not suitable for integration into a home.

Accordingly, the present inventors have determined that it would be desirable to develop a portable body waste collection and sanitation system with improved features for efficiently handling and disposing of liquid and solid waste while conserving water use and minimizing odors. In addition, the present inventors have recognized a need for such an improved system specifically designed for in home use where piped water is unavailable. Moreover, the present inventors have recognized a need for such a system having a modular design for providing easy access to various components to facilitate cleaning and repair, and to accommodate various arrangements as desired. Additional aspects and advantages will be apparent from the following detailed description of example embodiments, which proceeds with reference to the accompanying drawings. It should be understood that the drawings depict only certain example embodiments and are not to be considered as limiting in nature.

### BRIEF DESCRIPTION OF THE DRAWINGS

FIGS. 1-4 illustrate various views of a toilet in a closed condition in accordance with one embodiment.

FIG. 5 illustrates a view of the toilet of FIG. 1 with a seat cover removed to illustrate interior portions of a separating toilet assembly in accordance with one embodiment.

FIGS. 6-7 illustrate details of the toilet of FIG. 1 with the hinged lid raised to illustrate interior components of the toilet, including solid and liquid waste receptacles.

FIG. 8 is an exploded view of the toilet of FIG. 1 illustrating the various components of the toilet in accordance with one embodiment

FIGS. 9-10 illustrate details of another embodiment of a simplified toilet system operating as a bucket latrine.

### DETAILED DESCRIPTION OF EXAMPLE EMBODIMENTS

With reference to the drawings, this section describes embodiments and their detailed construction and operation of a portable body waste collection and sanitation system. The embodiments described herein are set forth by way of illustration only and not limitation. Throughout the specification, reference to “one embodiment,” “an embodiment,” or “some embodiments” means that a described feature, structure, or characteristic may be included in at least one embodiment of the system or of the components being discussed. Therefore, appearances of the phrases “in one embodiment,” “in an embodiment,” or “in some embodiments” in various places throughout this specification are not necessarily all referring to the same embodiment. Further, the described features, structures, characteristics, and methods of operation may be combined in any suitable manner in one or more embodiments. In view of the disclosure herein, those skilled in the art will recognize that the various embodiments can be practiced without one or more of the specific details or with other methods, components, materials, or the like. In other instances, well-known structures, materials, or methods of operation are not shown or not described in detail to avoid obscuring more pertinent aspects of the embodiments.

With general reference to the figures, the following disclosure relates to an improved, modular toilet system 100, 200 for providing improved sanitation and human waste disposal in homes and other structures where piped water systems are nonexistent or impractical, such as in impoverished regions or lands that may be vulnerable to flooding and erosion. In some communities, problems with land erosion are so severe that homeowners and agencies are reluctant to invest in piping and sewage infrastructure due to the short useful shelf-life of such systems under these conditions, thereby creating health risks and problems that could be remedied or avoided altogether with the disclosed sanitation system further described below.

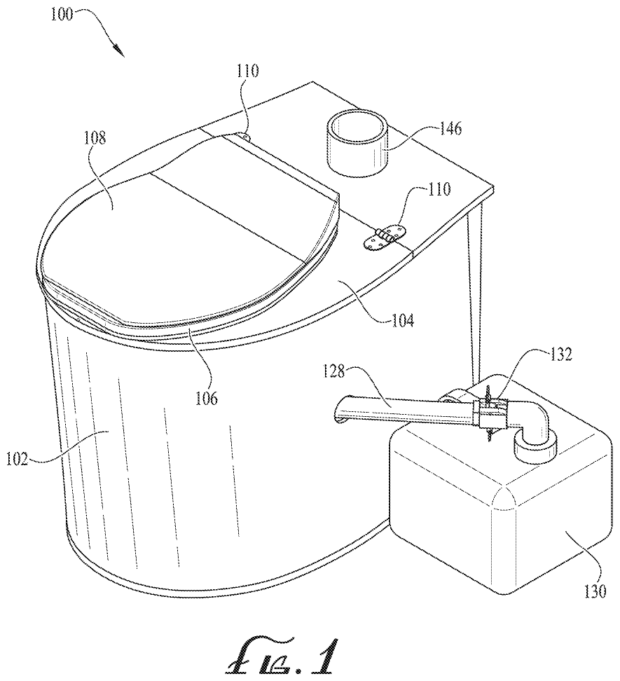

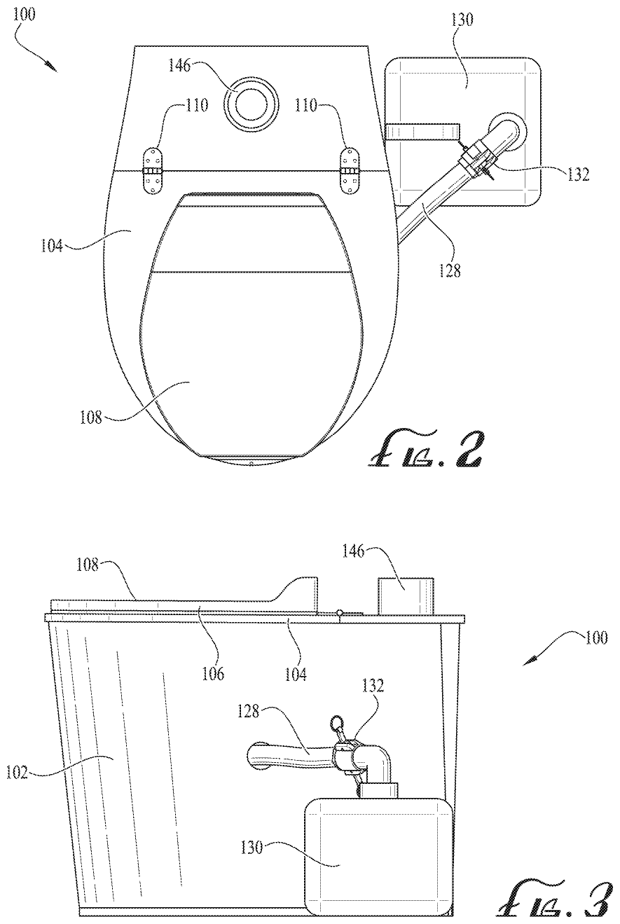

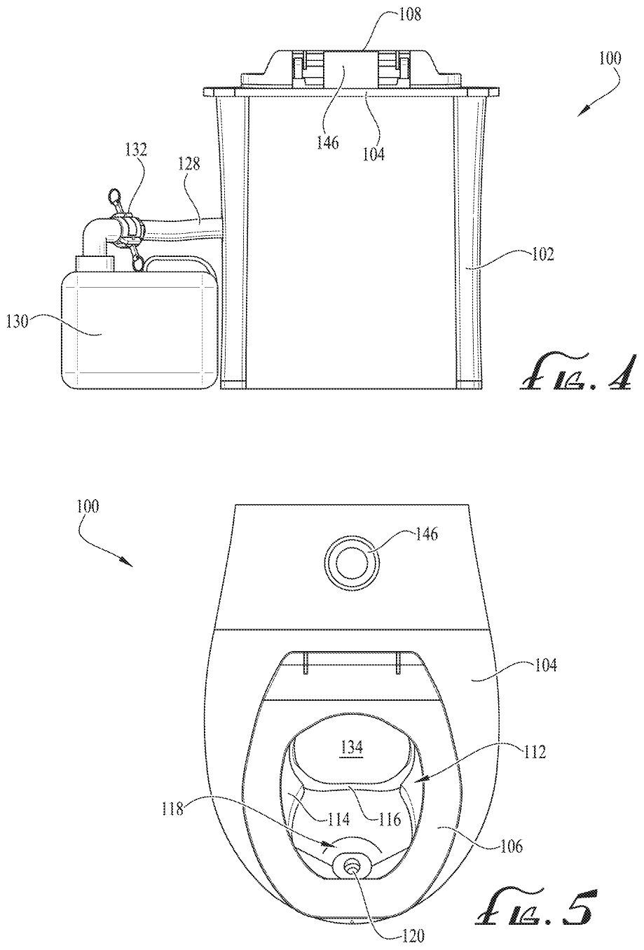

As collectively illustrated in FIGS. 1-10, the toilet 100, 200 includes various modular components arranged to handle and dispose of human waste while minimizing odors and potential exposure to harmful pathogens. As described in further detail below, the toilet 100, 200 is designed as a stand-alone model with components that are easily assembled and disassembled to maximize portability of the toilet 100, 200, thereby allowing the toilet 100, 200 to be dismantled and transported as needed, such as when homes are moved to new sites due to eroding coastlines or for other reasons. In addition, the toilet 100, 200 provides privacy, safety, cleanliness, and a streamlined design that can be implemented at a relatively low cost. Accordingly, in addition to being a potential solution for areas with land erosion issues, the sanitation system 100 may be used in underdeveloped and impoverished regions, and/or may be used in other locations where access to basic sanitation facilities may be limited, such as camp grounds, deserts, and beaches.

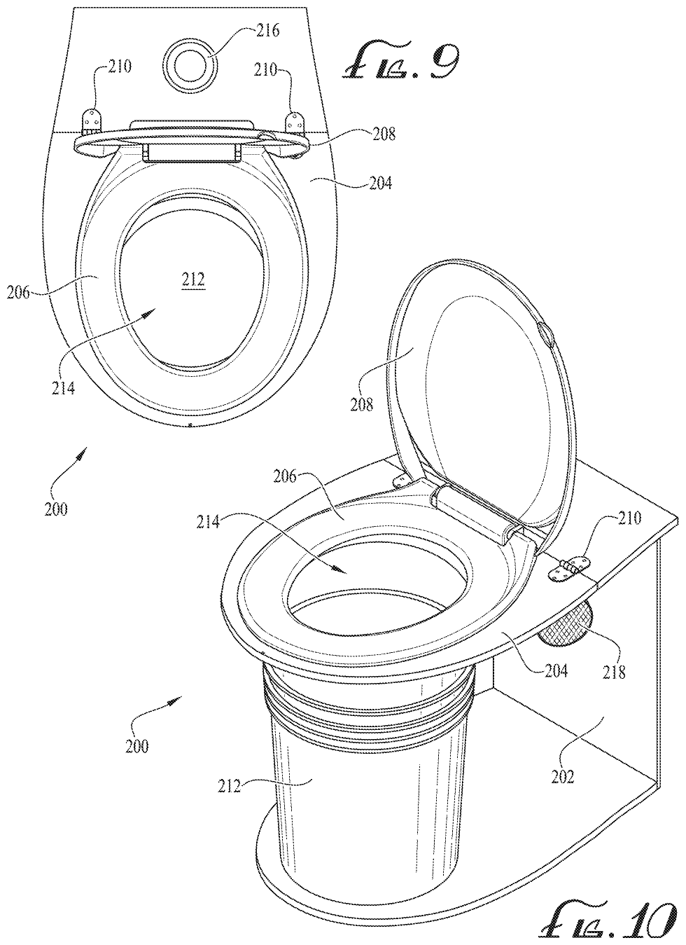

Moreover, as further described in detail below with particular reference to FIGS. 9-10, the toilets 100, 200 are designed so that the toilet 100 can be converted into the more simplified design of the toilet 200 (and vice versa), thereby facilitating conversion between a waste-separating toilet (e.g., toilet 100) and a non-waste-separating toilet 200 (and vice-versa) when desired to maximize flexibility and use of the toilet system. Additional details of these and other embodiments are further discussed below with reference to the accompanying figures.

FIGS. 1-5 collectively illustrate views of a toilet 100 designed to receive and separate solid waste and liquid waste for subsequent disposal. With general reference to FIG. 1, the toilet 100 includes a generally upright base 102 supporting a lid 104, a toilet seat 106, and a toilet seat cover 108. The seat 106 and seat cover 108 are coupled to the lid 104 via hinges (not shown) or other suitable fasteners designed to support upward and downward movement of the seat 106 and cover 108 as in a conventional toilet. The base 102, lid 104, and seat 106 are generally designed to support the user during seated use of the toilet 100. As illustrated in FIG. 1, the lid 104 is coupled to the base 102 via hinges 110 to accommodate a swinging open and close motion of the lid 104. This swinging action of the lid 104 provides access as may be needed to empty waste collected in the toilet 100 and/or to repair interior components of the toilet 100 as further described below.

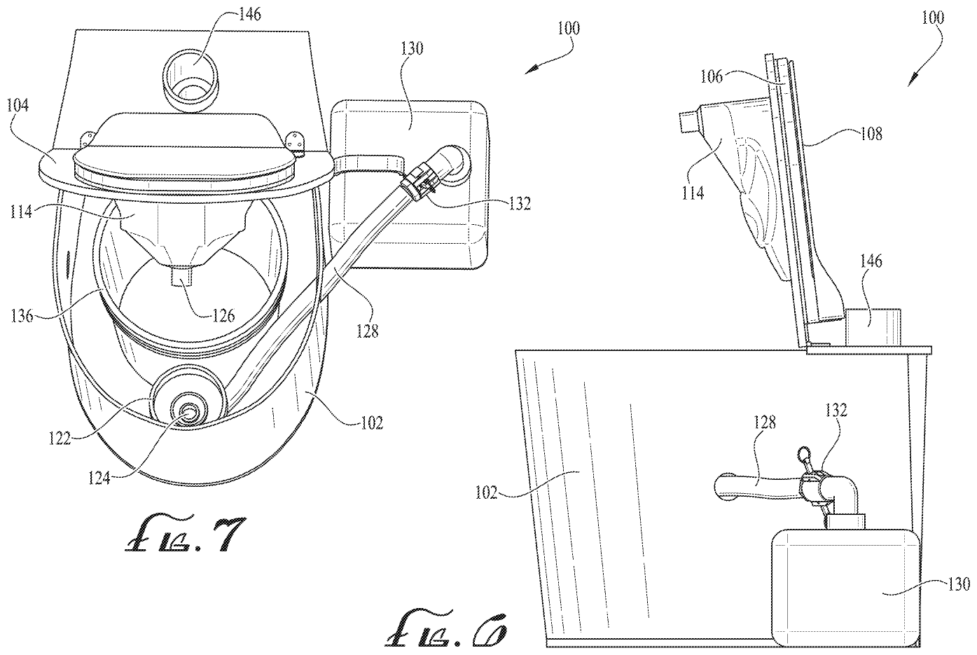

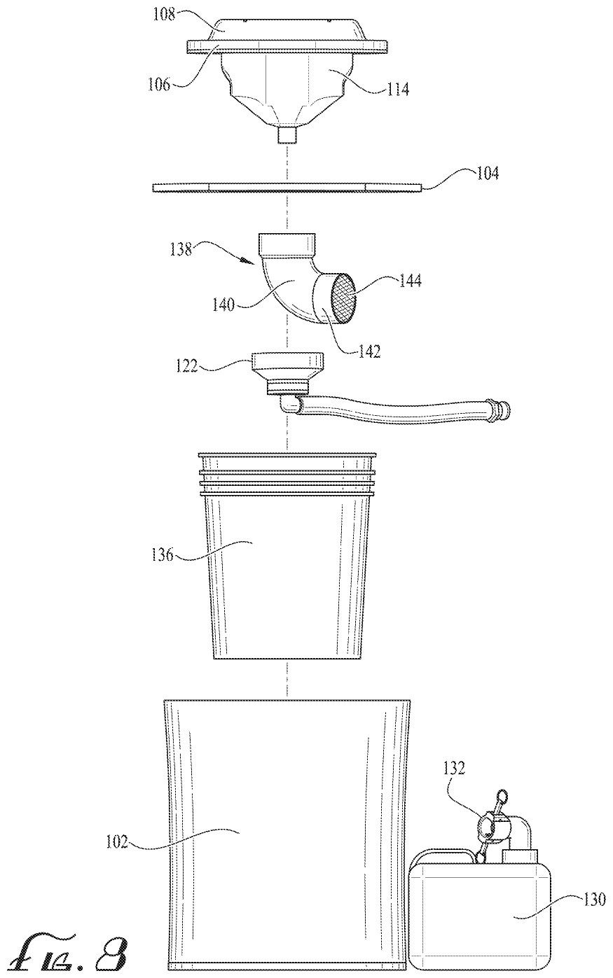

FIG. 5 illustrates the toilet 100 with the seat cover 108 removed to illustrate interior components of the toilet 100. With reference to FIG. 5, the toilet 100 further includes a waste intake system 112 positioned underneath the toilet seat 106, where the waste intake system 112 is designed to receive waste and separate liquid and solid waste. In one embodiment, the waste intake system 112 may include a separator toilet assembly 114 having a separating or diverting wall 116 extending across the waste intake system 112 to compartmentalize the intake system 112 into two regions, the separating wall 116 diverting liquid waste (e.g., urine) toward the front region of the intake system 112, and solid waste (e.g., fecal matter) toward the rear region of the intake system 112. In some embodiments, the toilet seat 106, seat cover 108, and separator toilet assembly 114 may be formed as a single, integral unit. In other embodiments, the components may be separate and coupled to one another using suitable fastening mechanisms. Additional details relating to waste collection aspects of the toilet 100 are described further with reference to FIGS. 6 and 7.

FIGS. 6 and 7 illustrate details of the toilet 100 of FIG. 1 with the hinged lid 104 raised to illustrate interior components of the toilet 100, including solid and liquid waste receptacles. As briefly discussed previously with reference to FIG. 5, liquid and solid waste are diverted via the intake system 112. As illustrated in FIG. 5, the front portion of the intake system 112 includes a small trough 118 for collecting liquid waste and a drain 120 disposed at the bottom of the trough 118 for directing liquid waste away from the toilet 100 for disposal. Additional details relating to aspects of the intake system designed for liquid and solid collection are described in further detail with primary reference to FIGS. 6 and 7.

With reference to FIG. 7, in some embodiments, the toilet 100 includes a urine funnel assembly 122 positioned directly underneath the drain 120 and designed to collect liquid waste from the drain 120. The urine funnel assembly 122 includes a funnel 124 having an opening sized and dimensioned to receive a tube 126 positioned on an underside of the separator toilet assembly 114 and connected to the drain 120, where liquid waste travels from the drain 120 through the tube 126 and into the funnel 124 of the urine funnel assembly 122. Once liquid waste is received in the funnel 124, a hose 128 connected to the funnel 124 via the opening directs the liquid waste into a separate container 130 for manual disposal as needed. In such embodiments, gravity causes the liquid waste to funnel through the drain 120 into the urine funnel assembly 122 and to the container 130. In other embodiments, the hose 128 may instead direct liquid waste to an exterior seepage pit (not shown), in which case the container 130 may not be necessary. In some embodiments, the urine funnel assembly 122 may be supported against the base 102 via a catchment fitting (not shown) or other suitable support mechanism to ensure proper positioning of the urine funnel assembly 122. It should be understood that while the hose 128 is illustrated as extending from an interior portion to an exterior portion of the base 102 to the container 130, in other embodiments, the container 130 may be sufficiently compact such that it fits within the base 102. In such embodiments, the hose 128 would be contained within the interior portion of the base 102.

Preferably, the container 130 is made of a transparent or translucent material (e.g., plastic or other suitable material) to allow the liquid level within the container 130 to be readily determined. The container 130 may be coupled to the hose 128 via a quick-release camlock fitting 132 to facilitate decoupling of the container 130 for emptying as needed. If desired, a camlock cap or suitable valve (not shown) may be used to seal the camlock fitting 132 to prevent urine from dripping out of the container 130 during transport. In other embodiments, a plug may be inserted into the fitting (not shown) on the hose 128 to prevent dripping of any liquid waste in the hose 128 during removal of the container 130. In other embodiments, other suitable fittings or securement mechanisms may be used to couple the hose 128 and the container 130 and/or to prevent spillage during the disposal process. It should be understood that while the container 130 is illustrated in the figures as being on a particular side of the base 102, the container 130 may be positioned on either side of the base 102 as desired.

Returning to FIG. 5, the following describes components of the toilet 100 designed for handling solid waste. With reference to FIG. 5, the intake system 112 includes an opening or channel 134 positioned behind the separating wall 116, where the opening 134 is designed to receive solid waste from a user sitting on the toilet 100. The opening 134 is positioned at a suitable location to ensure compatibility with a range of users such that solid waste is primarily directed into the opening 134 of the intake system 112 instead of onto the separating wall 116 or the drain 120. As illustrated in FIG. 7, the toilet 100 further includes a receptacle 136 positioned within the base 102 and underneath the opening 134. Preferably, the receptacle 136 includes a sufficiently large opening to ensure it receives all solid waste passing through the opening 134. The receptacle 136 is designed to be easily removable from within the base 102 to dispose of accumulated solid waste as needed. In some embodiments, the receptacle 136 may include a container, such as a five-gallon bucket or other suitable receptacle operable to contain solid waste. In other embodiments, the receptacle 136 may be fitted with a solid waste bag to facilitate removal of solid waste without requiring removal of the receptacle 136 from the base 102.

To handle odors generated by the solid waste in the receptacle 136, the toilet 100 may include a toilet vent 138 (see FIG. 8) adjacent the receptacle 136, the toilet vent 138 operable to help dry the solid waste and also to control odor of the waste in the receptacle 136 during use. In one embodiment, the toilet vent 138 includes an elbow-shaped pipe fitting 140 having an end cap 142 with a mesh screen 144 on a front surface thereof. Preferably, the end cap 142 is removable from the pipe fitting 140 to allow for cleaning and/or repair as needed to ensure proper ventilation.

In one embodiment, the pipe fitting 140 is designed to fit in a tube 146 having an open end extending outwardly from the base 102 of the toilet 100 (see FIG. 1). The tube 146 may open onto an upper surface of the base 102 or may open onto any other surface of the base 102 as desired. In some embodiments, a hose (not shown) or other suitable fitting may be coupled to the tube 146 to direct airflow from the interior portion of the base 102 to another location (e.g., outside the room, building, or structure) to minimize any odors in the room with the toilet 100. In other embodiments, the pipe fitting 140 and tube 146 may be formed as one integral component instead of two mating components.

In some embodiments, the toilet 100 may further include a ventilation system (not shown) operable for quickly drying the solid waste and further controlling odors. The ventilation system may incorporate fans, filters, and/or odor eliminating devices instead of, or in addition to, the toilet vent 138 for more effective drying of solid waste and odor control. For example, in one embodiment, the toilet 100 may be continuously mechanically vented with a heavy-duty fan to ensure constant ventilation of the solid waste in the receptacle 136 and minimize odors within the bathroom and home.

In other embodiments, the system may be converted to function as a mechanically vented bucket latrine, if desired. FIGS. 9-10 illustrate features of the latrine embodiment. With collective reference to FIGS. 9-10, the toilet 200 eliminates many of the components of the toilet 100 to simplify the overall system. With reference to FIG. 10, the toilet 200 includes a base 202 (a portion of which is not shown) supporting a lid 204, a toilet seat 206, and a toilet cover 208 arranged in a similar fashion as toilet 100 described previously. The seat 206 and seat cover 208 are coupled to the lid 204 via hinges (not shown) and/or other fasteners designed to support upward and downward movement of the seat 206 and cover 208 as in a conventional toilet. As illustrated in FIG. 10, the lid 204 is coupled to the base 202 via hinges 210 to accommodate a swinging motion of the lid 204 as may be needed to empty waste collected in the toilet 200 as further described below.

The toilet 200 further includes a receptacle 212 positioned within the base 202 and directly underneath the opening 214 of the toilet seat 206. Preferably, the receptacle 212 includes a sufficiently large opening to ensure it receives all liquid and solid waste passing through the opening 214. The receptacle 212 is designed to be easily removable from within the base 202 to dispose of accumulated waste as needed. In some embodiments, the receptacle 212 may include a container, such as a five-gallon bucket or other suitable receptacle operable to contain the deposited waste. In other embodiments, the receptacle 212 may be fitted with a solid waste bag to facilitate removal of waste without requiring removal of the receptacle 212 from the base 202. To handle odors generated by the combined solid and liquid waste in the receptacle 212, the toilet 200 may further include a venting mechanism adjacent the receptacle 212 similar to the venting mechanism of toilet 100. For example, the toilet 200 may include a vent 216 coupled to an assembly with a removable mesh screen 218 to provide adequate ventilation. It should be understood that while not described in further detail to avoid obscuring more pertinent aspects of the embodiment in FIGS. 9-10, all features of the venting mechanism of the toilet 100 may apply equally to the toilet 200.

Preferably, the toilet 200 includes a ventilation system (not shown) operable for quickly drying the solid waste and further controlling odors, as both liquid and solid waste are stored in the receptacle 212. The ventilation system may incorporate fans, filters, and/or odor eliminating devices instead of, or in addition to, the toilet vent 216 for more effective drying of solid waste and odor control. For example, in one embodiment, the toilet 200 may be continuously mechanically vented with a heavy-duty fan to ensure constant ventilation of the solid waste in the receptacle 212 and minimize odors within the bathroom and home.

As illustrated in FIGS. 9-10, the toilet 200 is a more streamlined design where all liquid and solid waste is received and stored in a single receptacle 212. Since many of the components are eliminated in this design, the toilet 200 can be manufactured and installed in a more cost-effective manner as compared to the toilet 100. Moreover, while the receptacle 212 may require more frequent disposal of its contents as compared to the embodiment in FIGS. 1-8, odor issues may be minimized as a result.

While the toilet 200 may be manufactured simply to include the components illustrated in FIGS. 9-10, the toilet 100 illustrated in FIGS. 1-8 may optionally be converted into the simplified latrine embodiment illustrated by the toilet 200 as previously noted. With general reference to FIGS. 7-10, the following describes an example process for converting the toilet 100 into the simplified latrine in accordance with one embodiment.

The first step in the conversion process is to remove the receptacle 136 from within the base 102 to allow for easier access to the remaining interior components of the toilet 100. Thereafter, the hose 128 is decoupled from the urine funnel assembly 122 and removed from the base 102. After removal of the hose 128, the toilet seat 106, toilet seat cover 108, and separator toilet assembly 114 are decoupled (in some embodiments they are formed as a single combined unit) from underneath the lid 104 and removed. Thereafter, a standard toilet seat (not shown but similar to toilet seat 206 and seat cover 208) is mounted to the base 102. In some embodiments, the base 102 may be marked to indicate bolt locations for attaching the toilet seat to the base 102.

After the toilet seat has been attached, the urine funnel assembly 122 is removed from inside the base 102 to provide sufficient space for the receptacle 136. When the urine funnel assembly 122 has been removed, the receptacle 136 is positioned back within the base 102 and aligned to ensure it is directly underneath the opening in the toilet seat to capture all waste. If needed, a support, wedge, or lift may be positioned underneath the receptacle 136 to ensure that it is properly positioned for minimizing potential splashing as waste enters the receptacle 136. A bag or other suitable liner may be placed in the receptacle 136 to facilitate waste disposal as needed.

As illustrated in the figures, the focus of the description pertains primarily to embodiments of the toilet 100, 200 for handling liquid and solid waste. In other embodiments, a complete bathroom system may include the toilet 100, 200 and a standalone urinal (not shown) designed for handling liquid waste. The urinal is a waterless urinal designed to avoid the need to use water in handling liquid waste. Use of a separate urinal may help minimize the frequency of emptying the liquid waste container 130.

It should be understood that many of the features, components, and processes described in the embodiments of FIGS. 1-10 are for illustration purposes. Accordingly, one having ordinary skill in the art may rearrange the features and process steps described herein in any of the embodiments without departing from the principles of the disclosure. In addition, it is intended that subject matter disclosed in portion herein can be combined with the subject matter of one or more of other portions herein as long as such combinations are not mutually exclusive or inoperable. In addition, many variations, enhancements and modifications of the concepts described herein are possible.

The terms and descriptions used above are set forth by way of illustration only and are not meant as limitations. Those skilled in the art will recognize that many variations can be made to the details of the above-described embodiments without departing from the underlying principles of the invention.

1. A waste collection system comprising:
a base including an interior compartment;
a lid coupled to the base, the lid being movable to an open position to provide access to the interior compartment of the base;
a separator toilet assembly including a waste intake system having a liquid waste receptacle and a solid waste receptacle, the separator toilet assembly having a separating wall that divides the liquid and solid waste receptacles of the waste intake system, the liquid waste receptacle including a drain for receiving and funneling liquid waste and the solid waste receptacle including an opening for receiving solid waste;
a solid waste container positioned within the interior compartment of the base and underneath the opening of the solid waste receptacle for receiving solid waste passing through the opening, the solid waste container being removable from the interior compartment of the base;
a liquid waste container in communication with the drain of the liquid waste receptacle, the liquid waste container storing liquid waste passing through the drain; and
a ventilation system in operable communication with the solid waste container, the ventilation system operable to dry solid waste collected in the solid waste container.

2. The waste collection system of claim 1, further including a conduit coupled to the drain of the liquid waste receptacle and to the liquid waste container for directing flow of liquid waste from the drain to the liquid waste container.

3. The waste collection system of claim 2, wherein the conduit extends from the interior compartment and through an opening on the side wall of the base to the liquid waste container.

4. The waste collection system of claim 2, the conduit further including a quick-release fitting to facilitate decoupling of the conduit from the liquid waste container.

5. The waste collection system of claim 4, wherein the quick-release fitting further includes a seal mechanism operable to seal the fitting and block passage of liquid waste therethrough.

6. The waste collection system of claim 1, wherein the ventilation system further includes a vent tube coupled to the base, the vent directing air outwardly from the interior compartment of the base.

7. The waste collection system of claim 1, wherein the ventilation system further includes a pipe fitting having an end cap and a screen, the end cap and screen positioned within the interior compartment of the base.

8. The waste collection system of claim 7, wherein one or both of the end cap and screen of the pipe fitting are removable for repair and maintenance.

9. The waste collection system of claim 1, wherein the ventilation system further includes air circulation devices for facilitating drying of solid waste in the solid waste container.

10. The waste collection system of claim 1, further comprising a toilet seat coupled to the lid, wherein the separator toilet assembly is removably coupled to the toilet seat.

11. The waste collection system of claim 10, wherein the separator toilet assembly is removable from the toilet seat, and wherein the solid waste container is movable within the interior compartment to capture both liquid and solid waste passing directly through an opening of the toilet seat when the separator toilet assembly is removed.

12. The waste collection system of claim 1, wherein the lid is coupled to the base via a hinge to accommodate a swinging movement of the lid into the open position.

13. The waste collection system of claim 1, wherein the liquid waste receptacle further includes a tube coupled to the drain, the system further comprising a funnel assembly including a funnel coupled to the tube and a conduit coupled to the funnel for directing liquid waste into a liquid waste container.

14. A method for converting a waste-separating toilet into a non-waste-separating toilet, the waste-separating toilet including a base having an interior compartment, a lid coupled to the base, the lid being movable to an open position to provide access to the interior compartment of the base, a separator toilet assembly including a liquid waste receptacle and a solid waste receptacle, the separator toilet assembly having a separating wall that divides the liquid and solid waste receptacles, a solid waste container positioned within the interior compartment of the base and underneath the opening of the solid waste receptacle for receiving solid waste passing through the opening, the solid waste container being removable from the interior compartment of the base, a liquid waste container including a conduit extending through the base and in communication with the liquid waste receptacle, and a ventilation system in operable communication with the solid waste container, the ventilation system operable to dry solid waste collected in the solid waste container, the method comprising:
uncoupling the conduit of the liquid waste container from the base;
uncoupling and removing the separator toilet assembly from the base;
coupling a toilet seat to the base, the toilet seat having an opening corresponding to an opening formed on the lid; and
adjusting a position of the solid waste container within the interior compartment of the base to position the solid waste container underneath the openings on the lid and toilet seat, wherein the solid waste container receives both liquid and solid waste.
